(19) United States
(12) Patent Application Publication
(10) Pub. No.: US 2001/0055434 A1
(43) Pub. Date: Dec. 27, 2001

(54) Bearing adapter assembly for a skateboard truck

(76) Inventor: Richard Wershe, St. Clair Shores, MI (US)

Correspondence Address: Steven L. Permut, REISING, ETHINGTON BARNES, KISSELLE,, LEARMAN & MCCULLOCH, PC, P.O. BOX 4390, TROY, MI, 48099-4390, US

(21) Appl. No.: 09/884,209

(22) Filed: Jun. 19, 2001

Related U.S. Application Data
(60) Provisional application No. 60/212,254, filed on Jun. 19, 2000.

(51) Int. Cl. F16C 13/00

(52) U.S. Cl. 384/544

(57) ABSTRACT

An adapter assembly for a skateboard truck (14) that includes two bearings (20) mounted an axle (16) and having two washers (28) and sleeve sections (30) which intrude through central openings in the bearing about the axle and into a center spacer (36) which abut against the inside walls (38) of the bearings (20). Furthermore, an acorn nut fastens the assembly together and extends out beyond the wheel (18) with flat wrench engageable sides.

### TECHNICAL FIELD

The field of this invention relates to a bearing adapter assembly for a skateboard truck.

### BACKGROUND OF THE DISCLOSURE

Skateboards have long been made with a for and aft truck assembly mounted on the underside of the skateboard. Each truck assembly has an axle with two distal ends at opposite sides of the skateboard. The skateboard wheel is usually mounted via two bearings that are pre-assembled into an annular shape with an outer diameter sized to fit in the hub of the wheel and an inner diameter forming a central opening sized to fit about the axle.

These bearings and wheels are wearable parts.

Many wheels and bearings may be used during an individual skateboard's useful life. The problems occurs because the industry is not completely standardized and a different sized bearing may be purchased from the one that was on the original axle. The two most common bearing models are commonly referred to as the 608 bearings or the 6900 bearings.

The 6900 bearing, while it may be desired to replace the 608 bearing, has an inner diameter or central opening that is 8 mm large as opposed to the skateboard axle's 6 mm diameter that is designed for the 608 bearing.

What is needed is an adapter assembly that provides for the usage of a replacement bearing on an otherwise undersized axle.

### SUMMARY OF THE DISCLOSURE

In accordance with one aspect of the invention, skateboard bearing adapter assembly for providing a bearing to mount a skateboard wheel onto a skateboard truck includes at least one central tubular spacer being slidably and rotatably mounted onto an axle of a skateboard truck. The tubular spacer has side shoulders abutting opposing facing sides of a pair of spaced apart bearings. A pair of washers abutting opposite outer facing sides of the respective bearings. A pair of sleeve sections protrude through a central opening of each respective bearings.

Preferably, the sleeve sections are integrally formed with the respective washers to form “top-hat members. The sleeve sections further intrude into a central opening of the central tubular spacer and fill the gap between the inner diameter of the spacer and the outer diameter of the axle.

Alternately, the sleeve sections may be integrally formed with the central spacer and form a first stepped section of the spacer. The washers are separate members that abut the sleeve section. In another variation, the central tubular spacer has a second stepped portion further extending from each sleeve section to seat the washer thereon.

In another embodiment, the sleeve sections are formed in a separate tubular assembly that protrudes through a central bore of said tubular spacer.

In accordance to another aspect of the invention, a fastener nut has flat sides extending a distance sufficient to clear the axial extension of the outer wheel of a skateboard wheel when fastened at a truck axle such that a flat wench can operably engage the flat sides laterally at the side of the wheel.

### BRIEF DESCRIPTION OF THE DRAWINGS

Reference now is made to the accompanying drawings in which:

FIG. 1 is a fragmentary and partially segmented view of a skateboard and truck assembly that incorporates an embodiment of the invention;

FIG. 2 is an exploded view of the axle assembly shown in FIG. 1;

FIG. 3 is a view similar to FIG. 1 illustrating a second embodiment;

FIG. 4 is a view similar to FIG. 1 illustrating a third embodiment;

FIG. 5 is a view similar to FIG. 3 illustrating a variation of the second embodiment;

FIG. 6 is a view similar to FIG. 1 illustrating a further variation; and

FIG. 7 is a view similar to FIG. 1 illustrating a further variation to the second embodiment.

FIG. 8 is a view similar to FIG. 2 illustrating a further embodiment.

### DETAILED DESCRIPTION OF THE PREFERRED EMBODIMENT

Referring now to FIG. 1, a skateboard 10 has a top board 12 conventionally mounted to two truck assemblies 14. Each truck assembly 14 has two opposing axles 16 for mounting a wheel 18. For simplicity of the drawing only a single truck assembly 14 is shown with one axle 16.

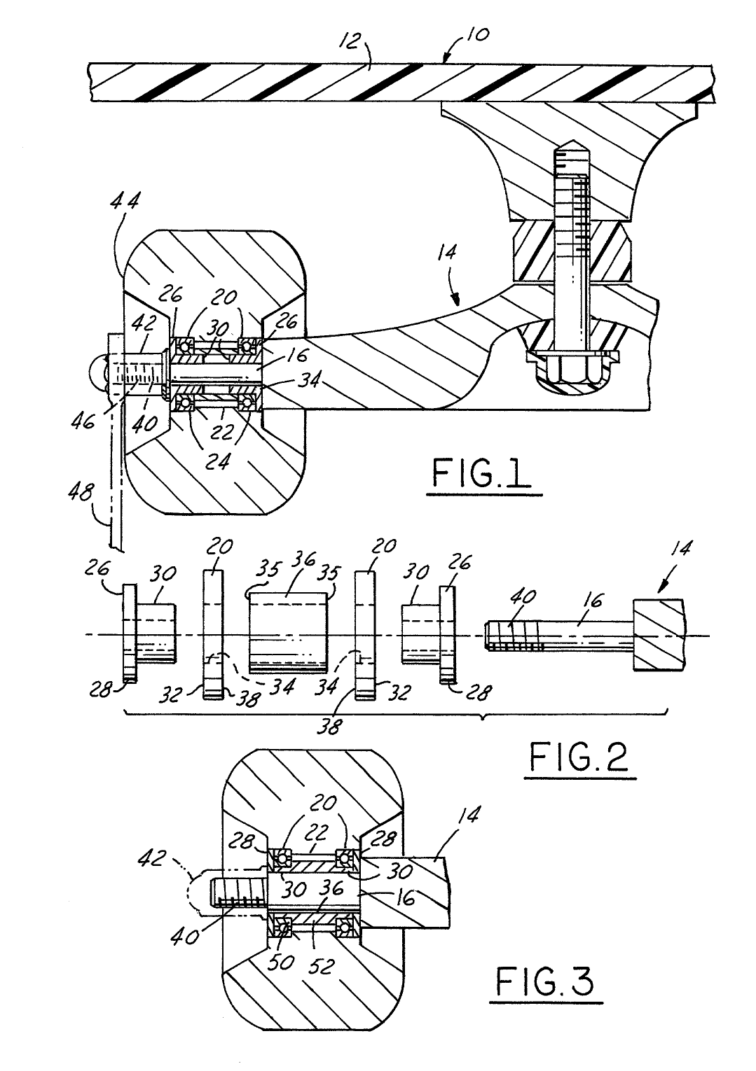

The axles 16 is dimensioned slightly under a diameter of 8 mm in order to receive a 608 bearing assembly. The 608 model bearing has an inner diameter of 8 mm. A pair of 6900 bearings labeled as 20 have an inner diameter of 10 mm and is mounted within the hub 22 of the wheel 18 and engages shoulders 24 of hub 22. A pair of combination top hat members 26 each having a washer section 28 and a sleeve section 30 are mounted also on the axle 16 such the washer abuts outer sides 32 of the bearings 20 and the sleeve section 30 protrudes through the central opening 34 of the bearing 20. The top hat and the following described parts are also shown more clearly in the exploded view of FIG. 2. The sleeve section 30 is dimensioned both to rotatably fit about axle 16 and to take up the gap between the axle 16 and the inner diameter of the bearing defined by the central opening 34. A tubular central spacer 36 is also mounted about axle 16 and interposed between two opposing facing sides 38 of the bearings 20 to abut and provide support for the bearing 20. More specifically, its ends 35 abut the sides 38 of bearings 20. The central spacer 36 has an inside diameter sized to receive the sleeve section 30 of the top hats 26 and the sleeve section extends a sufficient distance through the central opening and into the central spacer to take up the gap between the axle 16 and spacer 36.

The washer 20, in addition to providing extra space needed to compensate when a thinner 6900 bearing takes the place of the 608 bearing, also provides for a protective shield against dirt and grime from easily intruding to the bearing 20. Thus a cleaner and more durable bearing assembly is constructed.

Alternatively, the central spacer may have a inner diameter sized to directly engage the axle 16 and the sleeve sections may be shorted to merely abut against the ends of the central spacer in similar fashion as the bearings 20.

The axle 16 has an outer threaded end 40 which is engaged by a acorn type fastener nut 42. The nut 42 has an extended flat side walls 46 with axial dimension sufficient to extent beyond the outer side wall 44 of the wheel 18 such hat a conventional open wrench 48 may laterally engage the flat side walls at an axial distance beyond the side wall 44 of the wheel 18 as illustrated in FIG. 1.

Another embodiment is illustrated in FIG. 3 where like parts or sections have the same numerals as indicated for the first embodiment. In this embodiment, the sleeve sections 30 are integrally formed with the central spacer member 36 rather than with the washers 28. The sleeve sections protrude through the central openings 34 of the bearings 30 and have its outer ends abut opposite washers 28. The sleeve sections 30 form a step 50 with the central section 52 of the spacer member 36 which abuts the bearings 20. In this embodiment the inside diameter of the central spacer 36 fits closely about axle 16.

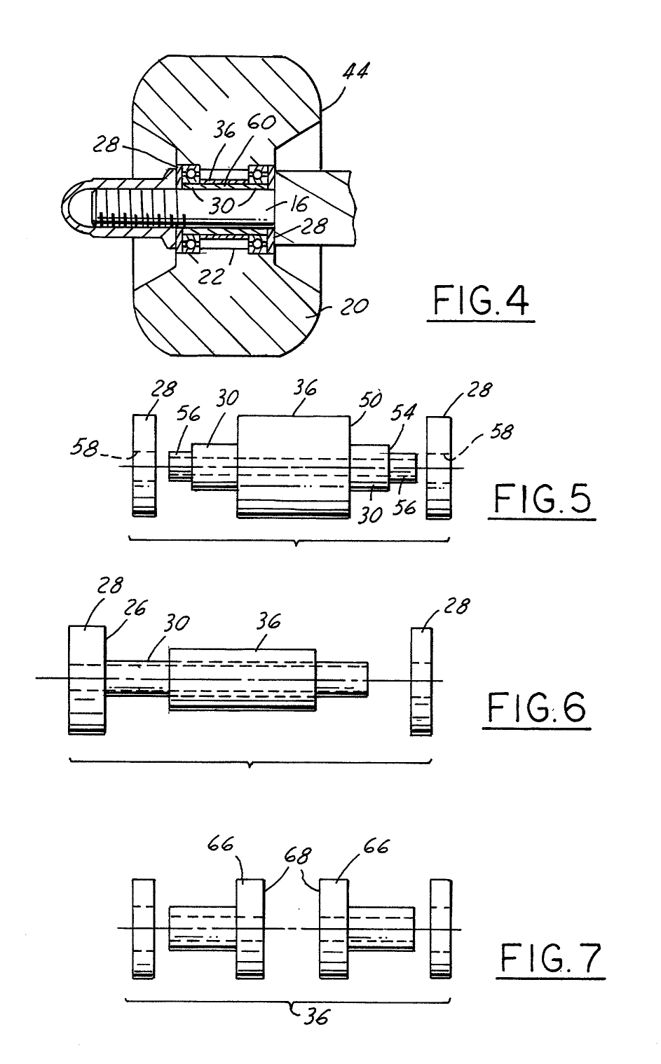

FIG. 4 illustrates a further variation wherein the sleeve sections 30 are formed by a unitary tubular member 60 that extends entirely through the central spacer 36 and through both bearings 20 and has opposite ends 62 that abut the washers 28.

FIG. 5 shows a slight modification to the central spacer member 36 which has two stepped section 50 and 54. The first stepped section steps down to the sleeve section 30 which protrudes through the bearing 20. The second stepped section 54 leads to a section 56 which protrudes through an enlarged opening 58 in the washers 28 such that the washers seat on the section 56 rather than directly on axle 16.

Another variation is disclosed in FIG. 6 which uses a top hat member 26 with an elongated sleeve section 30 that protrudes through both bearings and abuts a washer 28 at the opposite side. The tubular central spacer member also sits on the elongated sleeve section 30 and interposed between the two bearings 20.

FIG. 7 illustrates another variation where the central spacer stepped spacer 36 as shown in FIG. 3 may be spit into two member 66. When installed each member 66 has its inside walls 68 abut each other.

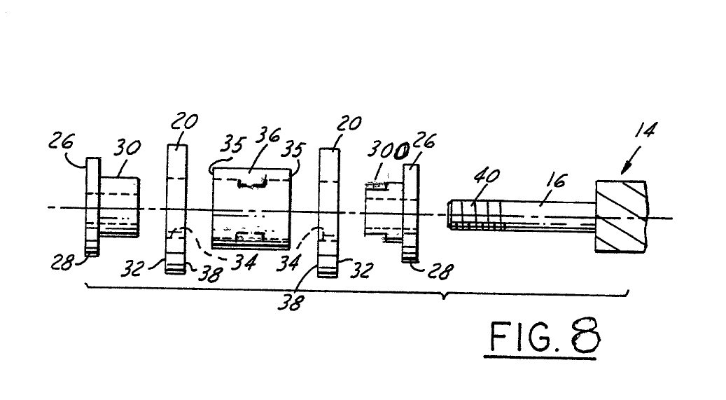

FIG. 8 illustrates another variation where the central spacing 36 has central stops 70 that abut the inner end of sleeve 30. Alternately, a modified sleeve 300 can have a step which fits and is seated within the stops 20.

In this fashion, a compact adapter assembly provides for the replacement of a bearing assembly on a skateboard wheel and accommodates for a choice of bearing assemblies. Furthermore, the ease of replacement to the desired bearing is enhanced via a unique extended acorn nut that allows lateral engagement of a simple open wrench to the side of the wheel.

Variations and modifications are possible without departing from the scope and spirit of the present invention as defined by the appended claims.

The embodiments in which an exclusive property or privilege is claimed are defined as follows:

1. A skateboard bearing adapter assembly for providing a bearing to mount a skateboard wheel onto a skateboard truck; the adapter assembly comprising:
at least one central tubular spacer being slidably and rotatably mounted onto an axle of a skateboard truck, and having side shoulders abutting opposing facing sides of a pair of spaced apart bearings;
a pair of washers abutting opposite outer facing sides of the respective bearings;
a pair of sleeve sections protruding through a central opening of each respective bearings.

2. A skateboard having an adapter assembly as defined in claim 1, further comprising:
said sleeve sections being integrally formed with said at least one respective washer; and
said sleeve sections further extruding into a central opening of said central tubular spacer.

3. A skateboard having an adapter assembly as defined in claim 1, further comprising:
said sleeve sections being integrally formed with said central spacer and forming a first stepped section of said spacer.

4. A skateboard having an adapter assembly as defined in claim 3, further comprising:
said central tubular spacer having a second stepped portion further extending from each sleeve section to seat said washer thereon.

5. A skateboard having an adapter assembly as defined in claim 1, wherein said sleeved sections are formed in a separate tubular assembly that protrudes through a central bore of said tubular spacer.

6. A skateboard wheel assembly fastener nut comprising:
a fastener nut having flat sides extending a distance sufficient to clear the axial extension of the outer wheel of a skateboard wheel when fastened at a truck axle such that a flat wench can operably engage the flat sides laterally at the side of said wheel.
